(19) United States
(12) Patent Application Publication
(10) Pub. No.: US 2010/0087113 A1
(43) Pub. Date: Apr. 8, 2010

(54) STEAM PERMISSIVE AND WATER NON PERMISSIVE SCREEN, AND METHOD FOR MAKING SAME

(75) Inventors: Pierre-Etienne Bindschedler, Obernai (FR); Marie Valentin, Illkirch (FR); Remi Perrin, Bischoffsheim (FR)

Correspondence Address: YOUNG & THOMPSON, 209 Madison Street, Suite 500, Alexandria, VA, 22314, US

(73) Assignee: SOPREMA, Strasbourg (FR)

(21) Appl. No.: 12/527,100

(22) PCT Filed: Feb. 13, 2008
(86) PCT No.: PCT/FR08/50239

§ 371 Date: Aug. 13, 2009

(30) Foreign Application Priority Data
Feb. 14, 2007 (FR) 0753248

(51) Int. Cl. D04H 13/00; B32B 5/02; D06C 29/00

(52) U.S. Cl. 442/54; 442/58; 28/167

(57) ABSTRACT

The invention relates to a steam permissive and water non-permissive screen, particularly a sub-roof screen, a rain-proof screen, an air-proof screen or the like. The screen (1) is characterised in that it mainly includes a non-woven fabric made of a mat or a web of a majority of natural fibres (2), preferably vegetable fibres, that has been submitted to a binding operation by pressurised liquid jets, or hydrobinding, and to a hydrophobation process.

This invention relates to the field of products in the form of light and flexible screens, used in construction, civil engineering and public works as coating or protective covering, and it has as its object a water vapor-permeable and water-proof screen, in particular an under-roof screen, a rain screen, an air screen or the like, and its process of production.

Until recently, the screens of the above-mentioned type were generally made in the form of bituminous membranes with a small thickness, consisting of a non-woven framework of bitumen-coated synthetic fibers.

However, these bituminous screens are currently increasingly frequently replaced by synthetic screens that are called HPV, for high vapor permeability.

The two types of production of a vapor-permeable and water-proof screen mentioned above have several drawbacks since they use materials derived from fossil and non-renewable raw materials, require large amounts of energy for their production and their transformation, and/or are difficult and even impossible to recycle.

These various negative factors are particularly detrimental within the framework of the ICV (inventory of the life cycle) of products and endow the latter with a quite unfavorable ACV (analysis of the life cycle) result.

In addition, such a screen should meet criteria and requirements of EN 13859 standards.

Membranes that can form a water vapor-permeable and water-proof screen are already known by the documents EP-A-1 010 801, US-A-2002/0071944 and US-A-2006/0160453.

However, these known membranes all have complex composite structures (laminates) that comprise at least a first component that carries out the function of mechanical strength and at least a second separate component that carries out the function of water impermeability and gas permeability. In addition, the two above-mentioned functions should be combined during an additional stage of the process of production such as a stage for lamination, glue-backing, spraying, or the like.

There consequently exists a need for a screen of the above-mentioned type that overcomes the drawbacks that are mentioned above, while exhibiting approximately the same performances and properties and by having a cost that is approximately equivalent and relatively simple to produce.

To meet this need, this invention proposes a water vapor-permeable and water-proof screen, in particular an under-roof screen, a rain screen, an air screen or the like, characterized in that it is primarily (i.e., essentially or only) constituted by a non-woven material that is formed by a layer or a fabric primarily made of natural fibers, preferably of plant origin, having at least undergone one binding operation by pressurized liquid jets, or a spunlace operation, and a treatment for making the material water-repellent.

The invention also has as its object a process for the production of a vapor-permeable and water-proof screen, characterized in that it consists in providing natural fibers, preferably of plant origin, to form, optionally after carding, a non-woven fabric or non-woven layer with these fibers by mechanical or pneumatic napping, then in subjecting said layer to a consolidation operation by a spunlace operation or binding by pressurized liquid jets and, finally, in subjecting the consolidated non-woven fabric to a treatment for making the fabric water-repellent.

Thus, the invention provides a solution that makes it possible to satisfy the request expressed above and to make it possible to overcome the above-cited drawbacks. Actually, the screen according to the invention has a one-component composition since the consolidated fabric, whose fibers have been made hydrophobic, simultaneously ensures the functions of mechanical strength and water impermeability/gas permeability.

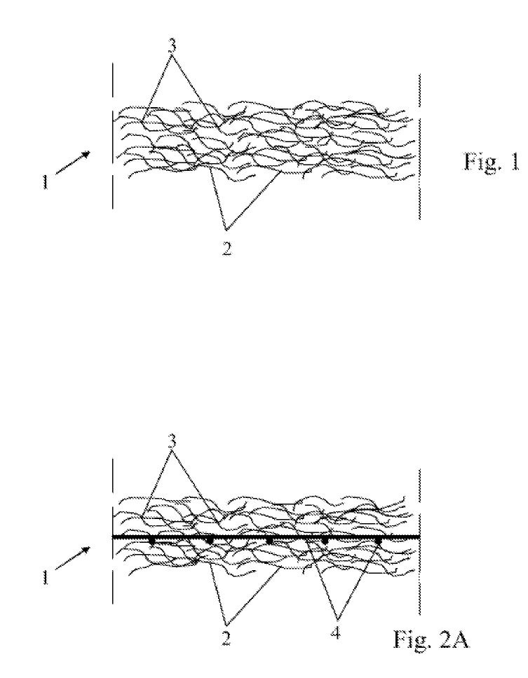

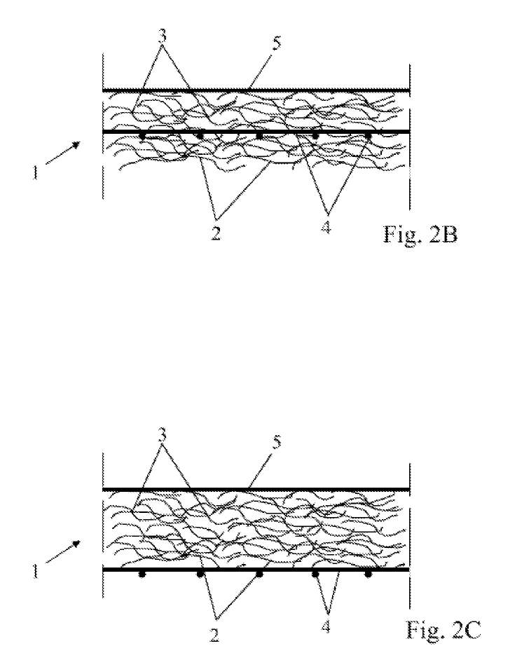

The invention will be better understood using the description below, which relates to preferred embodiments, provided by way of non-limiting example and explained with reference to the accompanying diagrammatic drawings, in which FIGS. 1 and 2 are partial cutaway views of a screen according to two embodiments of the invention, and whereby FIGS. 2A, 2B and 2C illustrate three variants of the second embodiment.

As FIGS. 1 and 2 show, the screen 1 is essentially (FIG. 2) or only (FIG. 1) composed of a non-woven material that is formed by a layer or a fabric that is primarily made of natural fibers 2, with essentially homogeneous distribution and with random orientation, preferably of plant origin, having undergone at least one binding operation by pressurized liquid jets, or a spunlace operation, and a treatment for making the material water-repellent.

Advantageously, the non-woven material in the form of a fibrous layer is formed by at least 75% by weight of natural fibers, preferably of plant origin. Said non-woven material can also be formed exclusively by such fibers.

Preferably, the non-woven fibrous layer has a surface weight of between 75 g/m² and 500 g/m², advantageously between 100 g/m² and 300 g/m², preferably on the order of 150 g/m², and a thickness that is less than 2.5 mm, preferably on the order of 1.0 mm.

According to a first variant embodiment, the natural fibers 2, forming exclusively or primarily said non-woven material, are plant fibers that may or may not be treated, selected from the group that is formed by the fibers of linen, cotton, jute, hemp, bamboo, kenaf and sisal, as well as mixtures of such fibers.

Advantageously, the plant fibers 2 (treated or not) are primarily or only composed of linen fibers, in the form of oakum made of linen and/or refined linen fibers.

According to a second variant embodiment, the natural fibers 2, forming completely or primarily said non-woven material, are fibers of synthetic material(s) of plant origin, selected from the group that is formed by viscose fibers, the synthetic fibers that are derived from cellulose (for example, of the LYOCELL type (filed name) of the LENZING Company) and the possible mixtures of these fibers.

The treatment for making material water-repellent is to endow the layer with its water impermeability property (the cellulose plant fibers are naturally hydrophilic) while not assuming, in any case not significantly, its permeability to gases, and more particularly to water vapor, which is due to its discontinuous structure.

As treatment for making the layer or fabric water-repellent or water-proof, treatments involving coating, impregnation or covering with the addition of a water-repellent reagent or water-proofing substance in significant quantities, whereby said treatment is liable to result in a continuous or almost-continuous gas-tight surface structure, should therefore be avoided.

However, if such a treatment should prove necessary or advisable, the selected substances and materials should have adequate intrinsic properties for water vapor permeability.

According to a preferred embodiment of the invention, the treatment for making the layer or fabric water-repellent is such that the treated natural fibers 2 have fatty acid chlorides that are grafted onto their structure, resulting from a chemical grafting by chromatogeny and endowing said fibers with a hydrophobic nature, whereby these fatty acid chlorides are advantageously selected from the group that is formed by palmitic acid chlorides and stearic acid chlorides.

The non-woven layer has, in a natural manner, because of the type of fibers used, a consolidation without supply of binding or adhesive agent, whereby said fibers 2 are connected to one another by the cross-linked pectins that are released during the spunlace operation.

This pectic binding of the fibers 2 to one another can, if necessary depending on the nature of the fibers that are used, from the intensity of the spunlace operation and the desired minimal properties and characteristics, be sufficient by itself to ensure the mechanical performance of the screen 1.

However, when the application that is considered requires it or when their type naturally does not involve a connection between them, said natural fibers 2 are connected to one another, if necessary in an additional way, by a related binding agent 3, applied during a binding operation or activated during a heat treatment operation undergone by the layer of spunlaced natural fibers.

For the purpose of preventing a negative impact on the ACV of the screen according to the invention, it may be advantageously provided that the related binding agent, making the plant fibers 2 integral with one another, is a binder of natural origin, for example plant or optionally animal, for example a binder that is selected from the group that is formed by binders based on gluten or starch, in particular corn (for example, keratin or a similar protein).

In addition to the above-mentioned examples of binders of plant origin, such a binder can also be selected from among the collophane ester (polymer of abietic acid−aqueous dispersion resin), soy glue (proteinic in nature), casein (proteinic in nature−dry material in aqueous phase), and natural rubber latex (polyisoprene+proteins−in aqueous phase).

According to another variant for consolidation of the layer, essentially limiting the negative impact in terms of ACV, the related binding agent, making the plant fibers 2 integral with one another, is a thermosetting binder of organic origin with a low melting point, in particular with a melting point of between 100° C. and 230° C., for example resulting from the fusion of thermoplastic synthetic fibers mixed with natural fibers of plant origin in an essentially homogeneous way, before or during the formation of the non-woven layer and present within a percentage by weight of less than 25%, preferably on the order of 15%.

Finally, when the application under consideration requires increased characteristics of resistance and/or mechanical strength, in particular an enhancement of the resistance to tearing on a nail, the screen can also comprise a reinforcement structure 4, integrated in the thickness of the layer of natural fibers 2 during the production process (FIGS. 2A and 2B) or connected to the latter (FIG. 2C), whereby this reinforcement structure 4 can consist of a grid made of glass or polymer or a grid made of a natural material, in particular based on plant fibers, preferably cotton, whereby this last solution completely preserves the positive result in terms of ACV.

So as to increase the service life of the screen 1 that results and the preservation of its characteristics over time, the non-woven layer is formed by natural fibers 2 that have undergone a treatment by spraying or impregnation, with agents that can modify at least some of their mechanical, chemical and/or physical characteristics, by increasing in particular their resistance to fire and to aging, their hydrophobic nature, and/or their UV resistance, and/or by enhancing their resistance to animal and/or insect pests.

Such a treatment can be aimed in particular at releasing the plant fibers 2 from the easily degradable organic components while preserving components with a long service life and without significantly affecting the mechanical characteristics of said fibers, or in impregnating or coating these fibers.

As FIGS. 2B and 2C of the accompanying drawings show, and when enhanced liquid resistance is desired (for example, enhanced water resistance: class W1 according to the standard EN 13859-1 or EN 13859-2), screen 1 can exhibit a composite structure and the non-woven fabric can comprise on one of its surfaces, designed to form the visible surface, a film 5 that is impermeable to liquid water but permeable to water vapor and is made of a natural polymer material, such as a polymer of plant origin or an agro-polymer, whereby said film 5 has, for example, a thickness of between 10 and 100 μm and is, for example, made integral with the non-woven material by calendering or extrusion coating. It will be noted that the addition of such a film is in no way detrimental in terms of ACV.

As a variant, and according to a slightly more detrimental approach in terms of ACV, the fabric, on one of its surfaces, designed to form the visible surface, can comprise a film 5 that is impermeable to liquid water but is permeable to water vapor and is made of a synthetic or plastic, preferably recyclable, polymer material, such as polyethylene, polypropylene, polyurethane or the like, whereby said film has, for example, a thickness of between 10 and 50 μm and is made integral, for example, with the non-woven fabric by calendering.

This invention also has as its object a process for production of a screen 1 of the type that is described above, whereby said process essentially consists in providing natural fibers 2, preferably of plant origin, in forming, optionally after carding, a non-woven fabric or a non-woven layer with these fibers by mechanical or pneumatic napping, then subjecting said fabric to a consolidation operation by a spunlace operation or binding by jets of pressurized liquid, and, finally, in subjecting the consolidated non-woven fabric to a treatment for making the fabric water-repellent.

The layer can be formed by a known formation process of the mechanical, pneumatic or hydraulic type.

According to a characteristic of the invention, the napping density is regulated such that the grammage or the specific mass of the resulting layer is between 75 and 500 g/m², advantageously between 100 and 300 g/m², preferably on the order of about 150 g/m², whereby the consolidation operation reduces the thickness of the layer such that its thickness at rest, in the absence of stress, is less than 2.5 mm, preferably on the order of 1.0 mm.

The type of natural fibers 2 that form the layer emerges from the possibilities indicated above.

Advantageously, the spunlace operation is carried out under such conditions, in particular in terms of duration and intensity, that it achieves an at least partial release of the pectins that are contained in the plant fibers 2, whereby these released pectins are then allowed to cross-link.

According to a preferred embodiment of the invention, the treatment for making material water-repellent consists in grafting fatty acid chlorides on the structures of the natural fibers of the non-woven fabric by an operation for chemical grafting by chromatogeny, preferably after consolidation, the fatty acid chlorides being selected from the group that is formed by the palmitic acid chlorides and the stearic acid chlorides.

The quantities of grafted fatty acid chlorides are advantageously less than 1% by weight of the fibers 2 that form the fabric, preferably on the order of 0.2 to 0.3% by weight, whereby chromatogeny allows homogeneous grafting in even such a small quantity.

The above-mentioned grafting operation can be derived from, for example, the one that is described in European Patent No. 1 007 202 and in the U.S. Pat. No. 6,342,268, whose contents are integrated into the present by reference.

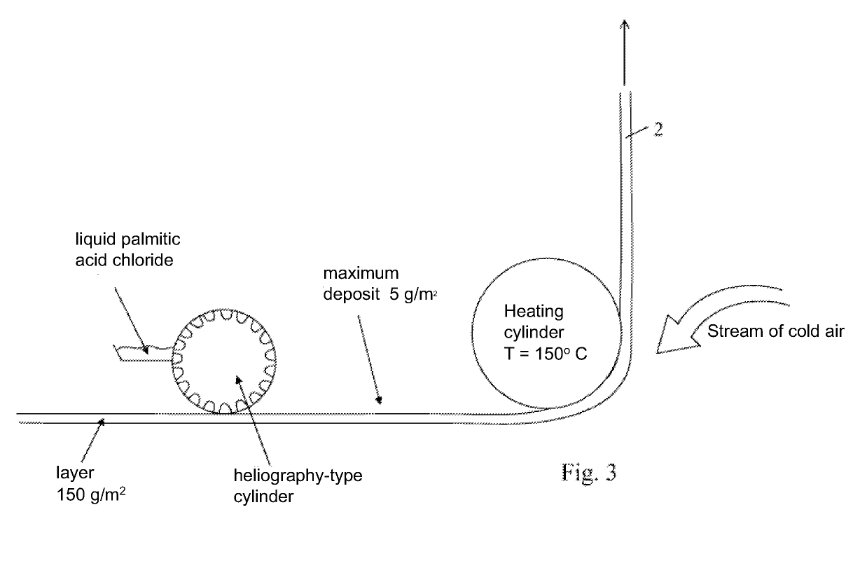

FIG. 3 shows diagrammatically a possibility for production of such a treatment for making a fabric water-repellent, as well as an installation for its implementation.

As this figure shows, the fatty acid chloride is deposited by standard printing techniques at a rate of about 5 g/m². The passage over the heating cylinder vaporizes the acid chloride that is grafted (it is in the gas phase) onto the hydroxyl groups (OH) of the natural fibers.

This reaction takes place in 1 to 2 seconds and releases—as reaction residue—very small quantities of hydrochloric acid that are drawn in and then condensed.

As a variant, the hydrophobic nature of the natural fibers 2 can also be attained by, for example, a treatment with fluorine.

Thus, a non-woven layer that consists of 100% linen fibers (oakum E2) and is consolidated by a spunlace operation is impregnated, for example by sizing, with an aqueous solution of PHOBOTEX JVA of the HUNTSMANN Company, so as to deposit about 8 g/m² of PHOBOTEX on the fibers of the layer.

Such a layer meets the conditions of a W2 classification according to the standard EN 18859-1 provided that the diameter of the median pores measured with a PSM 165 porometer is on the order of 25 μm and in no case greater than 75 μm.

Regardless of the treatment method for making fibers water-repellent, the purpose of the invention is ultimately to strike a compromise at the level of the mean diameter of the pores of the layer so that the latter is simultaneously water-proof and water-vapor-permeable according to expected values for the type of products targeted by the invention. Such a result can be achieved by successive approximation within the framework of production tests implementing one or the other of the above-mentioned variants and based on the respective degrees of permeability and impermeability desired.

In addition, the layer that is obtained according to the invention in agreement with the processes above exhibits the mechanical characteristics that are required for the targeted application, whereby these characteristics are not significantly affected by the treatment for making the fabric water-repellent.

According to one or several possible additional characteristics for the process according to the invention, the latter can also consist in:
Combining an additional reinforcement structure 4 with the non-woven fabric by integrating it in said fabric, during napping or during consolidation, or by connecting it to one of the surfaces of the latter, whereby this structure 4 is selected from the group that is formed by the glass grids, polyester grids, and grids made of a natural material, for example based on plant fibers, such as cotton or the like;
Subjecting the natural fibers 2, before napping or after obtaining consolidated, non-woven fabric, to a treatment by spraying or impregnation, with agents that can modify at least some of their mechanical, chemical and/or physical characteristics, by increasing in particular their resistance to fire and to aging, their hydrophobic nature, and their UV resistance;
Subjecting the non-woven fabric, after a spunlace operation, to an additional consolidation operation, either by spraying or impregnation with a binding agent of natural origin, for example, of plant or optionally animal origin, for example a binding agent that is selected from the group that is formed by gluten- or starch-based binders, in particular corn-based binders, or by a pressurized heat treatment, for example by hot calendering, whereby the non-woven fabric then consists of an essentially homogeneous mixture of natural fibers and thermosetting fibers of organic origin with a low melting point, preferably between 100° C. and 230° C., whereby the percentage by weight of said thermosetting fibers in the mixture is less than 25%, preferably on the order of about 15%.
Connecting to one of the surfaces of the non-woven fabric a film 5 that is impermeable to liquid water but permeable to water vapor and is made of a natural polymer material, such as a polymer of plant origin or an agro-polymer, whereby said film has, for example, a thickness of between 10 and 100 μm and is made integral with, for example, the non-woven material by calendering.
Connecting to one of the surfaces of the non-woven fabric a film 5 that is impermeable to liquid water but permeable to water vapor and is made of a synthetic or plastic, preferably recyclable, polymer material, such as polyethylene, polypropylene, polyurethane or the like, whereby said film has, for example, a thickness of between 10 and 50 μm and is made integral with, for example, the non-woven material by calendering.

Of course, the invention is not limited to the embodiments described and shown in the accompanying drawings. Modifications are possible, in particular from the standpoint of the composition of the various elements or by substitution of technical equivalents, without thereby exceeding the scope of protection of the invention.

1-33. (canceled)

34. Water vapor-permeable and water-proof screen, such as an under-roof screen, a rain screen, an air screen or the like, characterized in that it primarily consists of a non-woven material formed by a layer or a fabric primarily made of natural fibers (2), preferably of plant origin, having at least undergone one binding operation by pressurized liquid jets, or a spunlace operation, and a treatment for making plant fibers water-repellent, whereby this last treatment does not significantly affect the permeability of the layer to gases, in particular to water vapor, which is due to its discontinuous structure.

35. Screen according to claim 34, wherein the non-woven material in the form of a fibrous layer is formed with at least 75% by weight of natural fibers, preferably of plant origin.

36. Screen according to claim 34, wherein the non-woven material in the form of a fibrous layer is formed exclusively by natural fibers, preferably of plant origin.

37. Screen according to claim 34, wherein the non-woven fibrous layer has a surface mass of between 75 g/m² and 500 g/m², advantageously between 100 g/m² and 300 g/m², preferably on the order of 150 g/m² and a thickness that is less than 2.5 mm, preferably on the order of 1.0 mm.

38. Screen according to claim 34, wherein the natural fibers (2), exclusively or primarily forming said non-woven material, are plant fibers that may or may not be treated and that are selected from the group that is formed by the fibers of linen, cotton, jute, hemp, bamboo, kenaf and sisal, as well as mixtures of such fibers.

39. Screen according to claim 36, wherein the plant fibers (2) that may or may not be treated primarily or only consist of linen fibers, in the form of oakum made of linen and/or refined linen fibers.

40. Screen according to claim 34, wherein the natural fibers (2), entirely or primarily forming said non-woven material, are fibers made of synthetic material(s) of plant origin, selected from the group that is formed by viscose fibers, synthetic fibers derived from cellulose, and the possible mixtures of these fibers.

41. Screen according to claim 34, wherein the natural fibers (2) have fatty acid chlorides that are grafted onto their structure, resulting from a chemical grafting by chromatogeny and endowing said fibers with a hydrophobic nature.

42. Screen according to claim 41, wherein the grafted fatty acid chlorides are selected from the group that is formed by the palmitic acid chlorides and the stearic acid chlorides.

43. Screen according to claim 34, wherein the natural fibers (2) are connected to one another by the cross-linked pectins that are released during the spunlace operation.

44. Screen according to claim 34, wherein the natural fibers (2) are connected to one another, if necessary in an additional way, by a related binding agent, applied during a binding operation or activated during a heat treatment operation undergone by the layer of spunlaced natural fibers.

45. Screen according to claim 44, wherein the related binding agent, making the plant fibers (2) integral with one another, is a binder of natural origin, for example of plant or optionally animal origin, for example a binder that is selected from the group that is formed by gluten- or starch-based, in particular corn-based, binders.

46. Screen according to claim 34, wherein the related binding agent, making the plant fibers (2) integral with one another, is a thermosetting binder of organic origin with a low melting point, in particular with a melting point of between 100° C. and 230° C., for example resulting from the melting of thermoplastic synthetic fibers that are mixed with natural fibers of plant origin in an essentially homogeneous way, before or during the formation of the non-woven layer and present with a percentage by weight that is less than 25%, preferably on the order of 15%.

47. Screen according to claim 34, wherein it also comprises a reinforcement structure (4), integrated into the thickness of the natural fiber layer or connected to the latter.

48. Screen according to claim 47, wherein the reinforcement structure (4) consists of a glass or polyester grid.

49. Screen according to claim 47, wherein the reinforcement structure (4) consists of a grid made of a natural material, in particular based on plant fibers, preferably cotton.

50. Screen according to claim 34, wherein the natural fibers (2) have also undergone a treatment, by spraying or impregnation, with agents that can modify at least some of their mechanical, chemical and/or physical characteristics, by increasing in particular their resistance to fire and to aging, their hydrophobic nature and/or their UV resistance and/or by enhancing their resistance to animal and/or insect pests.

51. Screen according to claim 34, wherein it has a composite structure and wherein the non-woven fabric comprises on one of its surfaces, designed to form the visible surface, a film (5) that is impermeable to liquid water but permeable to water vapor and is made of a natural polymer material, such as a polymer of plant origin or an agro-polymer, whereby said film (5) has, for example, a thickness of between 10 and 100 μm and is made integral with, for example, the non-woven material by calendering or extrusion coating.

52. Screen according to claim 34, wherein the non-woven fabric comprises on one of its surfaces, designed to form the visible surface, a film (5) that is impermeable to liquid water but is permeable to water vapor and is made of a synthetic or plastic, preferably recyclable, polymer material, such as polyethylene, polypropylene, polyurethane or the like, whereby said film has, for example, a thickness of between 10 and 50 μm and is made integral with, for example, the non-woven material by calendering.

53. Process for production of a vapor-permeable and water-proof screen, according to claim 34, wherein it consists of providing natural fibers (2), preferably of plant origin, to form, optionally after carding, a non-woven fabric or a non-woven layer with these fibers by mechanical or pneumatic napping, in then subjecting said fabric to a consolidation operation by a spunlace operation or binding by pressurized liquid jets and, finally, in subjecting the consolidated non-woven fabric to a treatment for making plant fibers water-repellent, whereby this last treatment does not significantly affect the permeability of the layer to gases, in particular to water vapor, which is due to its discontinuous structure.

54. Process according to claim 53, wherein the napping density is regulated so that the grammage or the surface mass of the resulting layer is between 75 and 500 g/m², advantageously between 100 and 300 g/m², preferably on the order of about 150 g/m², and wherein the consolidation operation reduces the thickness of the layer such that its thickness at rest, in the absence of stress, is less than 2.5 mm, preferably on the order of 1.0 mm.

55. Process according to claim 54, wherein the natural fibers (2) that form completely or primarily, preferably at least 75% by weight, the non-woven fabric, are plant fibers that may or may not be treated, selected from the group that is formed by the fibers of linen, cotton, jute, hemp, bamboo, kenaf and sisal, as well as the mixtures of two or more of the above-mentioned fibers.

56. Process according to claim 53, wherein the plant fibers (2) that may or may not be treated primarily consist of linen fibers, in the form of oakum made of linen and/or refined linen fibers.

57. Process according to claim 53, wherein the natural fibers (2) that form completely or primarily said non-woven fabric are fibers made of synthetic material(s) of plant origin, selected from the group that is formed by viscose fibers, fibers from derivatives of cellulose and the possible mixtures of these fibers.

58. Process according to claim 53, wherein the spunlace operation is carried out under conditions such that, in particular in terms of duration and intensity, it achieves an at least partial release of the pectins that are contained in the plant fibers (2), whereby these released pectins are then allowed to cross-link.

59. Process according to claim 53, wherein the treatment for making material water-repellent consists in grafting fatty acid chlorides onto the structures of the natural fibers of non-woven fabric by a chemical grafting operation by chromatogeny, preferably after consolidation.

60. Process according to claim 59, wherein the grafted fatty acid chlorides are selected from the group that is formed by the palmitic acid chlorides and the stearic acid chlorides.

61. Process according to claim 53, wherein it also consists in combining an additional reinforcement structure (4) with the non-woven fabric by integrating it into said fabric during napping or during consolidation, or by connecting it to one of the surfaces of the latter.

62. Process according to claim 61, wherein the additional reinforcement structure (4) is selected from the group that is formed by glass grids, polyester grids, and grids that are made of a natural material, for example based on plant fibers, such as cotton or the like.

63. Process according to claim 53, wherein it consists in subjecting the natural fibers (2), before napping or after obtaining the consolidated non-woven fabric, to a treatment by spraying or impregnation with agents that can modify at least some of the mechanical, chemical and/or physical characteristics by increasing in particular their resistance to fire and to aging and their hydrophobic nature.

64. Process according to claim 53, wherein it consists in subjecting the non-woven fabric, after a spunlace operation, to an additional consolidation operation, either by spraying or impregnation with a binding agent of natural origin, for example of plant origin or optionally of animal origin, for example a binding agent that is selected from the group that is formed by the binders that are based on gluten or starch, in particular corn, or by a pressurized heat treatment, for example by hot calendering, whereby the non-woven fabric then consists of an essentially homogeneous mixture of natural fibers and thermosetting fibers of organic origin with a low melting point, preferably between 100° C. and 230° C., whereby the percentage by weight of said thermosetting fibers in the mixture is less than 25%, preferably on the order of about 15%.

65. Process according to claim 53, wherein it consists in connecting a film (5) that is impermeable to liquid water but permeable to water vapor and is made of a natural polymer material, such as a polymer of plant origin or an agro-polymer, to one of the surfaces of the non-woven fabric, whereby said film has, for example, a thickness of between 10 and 100 μm and is made integral with, for example, the non-woven material by calendering.

66. Process according to claim 53, wherein it consists in connecting a film (5) that is impermeable to liquid water but permeable to water vapor and is made of a synthetic or plastic, preferably recyclable, polymer material, such as polyethylene, polypropylene, polyurethane or the like, to one of the surfaces of the non-woven fabric, whereby said film has, for example, a thickness of between 10 and 50 μm and is made integral with, for example, the non-woven fabric by calendering.
